(19) United States
(12) Patent Application Publication
(10) Pub. No.: US 2006/0162752 A1
(43) Pub. Date: Jul. 27, 2006

(54) Method and device for effecting the, in particular, continuous surface treatment, especially cleaning, of a metal strip

(76) Inventor: Josef Speidl, Traun (AT)

Correspondence Address: OSTROLENK FABER GERB & SOFFEN, 1180 AVENUE OF THE AMERICAS, NEW YORK, NY, 100368403, US

(21) Appl. No.: 10/536,728

(22) PCT Filed: Aug. 21, 2003
(86) PCT No.: PCT/EP03/09280

§ 371 Date: Aug. 5, 2005

(30) Foreign Application Priority Data
Nov. 29, 2002 (AT) A 1789/2002

(51) Int. Cl. B08B 7/04; C23G 1/02; B08B 1/02; B08B 3/00; B08B 3/04; B08B 3/12

(52) U.S. Cl. 134/184; 134/15; 134/10; 134/103.1; 134/104.2; 134/41

(57) ABSTRACT

The invention relates to a device for operating and a method for modifying an installation for effecting the, in particular continuous, treatment, preferably the cleaning, of a metal strip 2 by means of a treatment liquid, particularly a pickling liquid, the metal strip 2 being guided, preferably horizontally, through at least one tank 1 for accommodating the treatment liquid, particularly a pickling tank, with at least one pump circulation tank, preferably two pump circulation tanks 3, for preparing or storing and/or holding the treatment liquid. In this case, at least one pump circulation tank (3) is arranged directly under the tank 1 for accommodating a treatment liquid.

The invention relates to a device for operating and a method for modifying an installation for effecting the, in particular continuous, treatment, preferably the cleaning, of a metal strip by means of a treatment liquid, particularly a pickling liquid, the metal strip being guided, preferably horizontally, through at least one tank for accommodating the treatment liquid, particularly a pickling tank, with at least one pump circulation tank, preferably two pump circulation tanks, for preparing and/or storing or holding the treatment liquid.

In the case of cleaning installations for the treatment of metal strips, in particular continuous strips, there arises the problem of a space requirement that is already in fact very high and is significantly increased further by the requirement for higher treatment rates. In principle, there is a requirement for higher pickling rates in order to increase the productivity of the treatment installations or to counteract a reduction in productivity in the treatment of thin strips.

Longer tanks or else a greater number of tanks and considerably enlarged strip accumulators comprise one possible way of meeting the requirement for higher pickling rates. However, these concepts lead to a significantly increased space requirement, and consequently to higher costs for the installation. In situations where the space at the treatment installation is restricted, an increase in the pickling rate, and consequently the productivity, of the treatment installation can scarcely be achieved, or only with very high costs.

Apart from installing longer tanks for accommodating the treatment liquid, it is known to use shallow tanks, leading to a more efficient treatment process, caused by great turbulence of the treatment liquid in the tanks. This measure allows a higher permissible strip speed to be achieved with the same length of the tanks, with the same or an improved treatment result.

By contrast with installations with deep tanks, treatment installations with shallow tanks require additional pump circulation tanks, which serve the purpose on the one hand of preparing the treatment liquid, but on the other hand also of holding the treatment liquid or, when emptying the tanks, accommodating the treatment liquid.

It is known from AT 407759 B to provide shallow tanks with special injection devices for the treatment liquid. In AT 407759 B, the installation concept with the pump circulation tank is also schematically represented, without disclosing a particularly space-saving arrangement.

It has been found to be disadvantageous that installations of this type have a very high space requirement in the strip running direction, but also in the direction of its width. This high space requirement often also represents a significant cost factor and, in situations where space is confined, may require very costly special solutions.

It is an object of the present invention to further develop a device according to the precharacterizing clause of claim 1, and a method according to the precharacterizing clause of claim 18, so that a particularly cost-effective and efficient method for effecting surface treatment can be realized.

At the same time, allowance is made in particular for the requirement for higher treatment rates, low-cost devices and efficient solutions for converting these devices into treatment installations.

The object is achieved in terms of the device according to the invention by the characterizing clause of claim 1, and in terms of the method according to the invention by the characterizing clause of claim 20.

It is possible by the measures according to the invention to create a very space-saving and compact treatment installation which permits a very efficient treatment, offers significant advantages with respect to operating costs and consequently improves the treatment process overall.

According to one embodiment of the invention, one or more pump circulation tanks are arranged directly under the tank for accommodating the treatment liquid. Pump circulation tanks serve for preparing the treatment liquid, but also for accommodating it when the tanks are emptied. The arrangement of the pump circulation tank or tanks directly under the tank has the effect of minimizing the difference in the levels of the treatment liquid in the tank and the treatment liquid in the pump circulation tanks. Since, to set the composition of the treatment liquid, it is constantly circulated during operation, the required pumping capacity is reduced by the reduced difference in levels. This results in significantly more efficient operation of the treatment installation.

According to one embodiment of the device, the tank for accommodating the treatment liquid is configured as a shallow tank with a cover. This allows detrimental effects of the treatment medium on the environment or the direct surroundings of the installation to be avoided. The configuration as a shallow tank makes it possible for the strip to interact very efficiently with the treatment liquid. This allows a particularly good treatment result on the metal strip to be ensured.

A further embodiment of the device provides that the pump circulation tank or tanks and the tank form a unit. The installation can be kept very compact, giving rise to advantages with regard to the space requirement and the procedure for assembling the parts of the installation in addition to the advantages already mentioned above.

According to one particular embodiment of the device, the tank is structurally mounted on one or more pump circulation tanks. This configuration allows very simple assembly and disassembly and permits a low-cost, simple design for the tanks and the pump circulation tanks. According to a special refinement, seals are provided on the contact surface between the tank and the pump circulation tanks. This ensures that volatile constituents of the treatment liquid, such as vapors for example, do not get into the surroundings.

In a very compact embodiment of the device, the bottom of the tank forms the cover for the pump circulation tank or tanks. This minimizes the space requirement and represents a considerable advantage in assembly and servicing work, since the components can be disassembled and serviced very easily. The difference in levels between the surfaces of the treatment liquid in the tank and in the pump circulation tanks can thereby be minimized.

A very advantageous configuration of the device is achieved by the tank and pump circulation tank being made of plastic, polypropylene being used in particular. This allows a long service life and great operational reliability to be ensured. The good processing properties, such as weldability, permit the construction of complex components and the combination of subassemblies to form a structural unit.

According to a further advantageous configuration of the device, the tank and pump circulation tanks consist of rubberized steel or else of other materials that are resistant to the treatment liquid, such as for example high-grade steel. This represents a very robust and operationally reliable solution and can be used for components that are assembled together. In particular, components which are in direct contact with the treatment liquid, such as the tank or pump circulation tank, can be advantageously made with it.

The device according to the invention has run-off chambers, which accommodate the treatment liquid leaving the tank, caused by the movement of the metal strip or by turbulences, and lead it into the pump circulation tank or tanks. The tank and the pump circulation tank or tanks are connected by means of an additional run-off, accommodating a change in length, so that the tank can be emptied in an easy manner via this run-off. The great lengths of the tanks and the increased operating temperatures cause considerable, thermally induced changes in length, which are accommodated by the run-off according to the invention.

As an advantageous refinement, the run-off between the tank and the pump circulation tank is provided centrally in the tank, seen in the strip running direction, the bottom of the tank being made to incline toward the run-off, so that complete emptying of the tank is constantly ensured during the running-off of the treatment liquid.

As a special embodiment of the device, the pump circulation tank has a bottom, having a slope over the entire length, the slope being aligned in the strip running direction. This refinement is very advantageous, especially in servicing or cleaning work, because it does not give rise to any additional work caused by residues of the treatment liquid remaining in the tank. Furthermore, it is advantageous to provide emptying stubs at the lowest point of the pump circulation tanks, to allow the treatment liquid to be drained off reliably.

For servicing and repair work, manhole or cleaning openings with a removable cover are provided, whereby operational downtimes, caused by necessary work, can be kept very short.

According to a particular configuration of the device, the run-off chambers respectively have a flap which is arranged between the separating wall and the outside wall of the run-off chamber and can be actuated from the outside. This flap permits gastight closure of the pump circulation tanks.

In cases of operational problems or servicing work on the squeeze rolls, it is necessary to keep down the detrimental effect of the treatment liquid on the surroundings, in particular for the servicing personnel. Maximum allowable concentrations are legally prescribed for this and must be observed. On account of the increased temperatures of the treatment liquid, it is necessary to close the pump circulation tanks with a gastight seal by means of flaps, and consequently to protect the servicing personnel from the harmful effects of the treatment liquid or gaseous constituents of it.

It has been found to be expedient to provide connecting lines between the tank and the pump circulation tanks. The great changes in volume during the draining of the treatment liquid into the pump circulation tank or tanks can cause the volume of air that is displaced as a result to be forced into the tank, without any detrimental effect on the surroundings by volatile constituents of the treatment liquid.

According to the invention, the difference in levels of the liquids between the tank and the pump circulation tank can be kept very small, so that it is possible to use shorter pipe systems and less energy for the delivery of the treatment medium by the pumps. For a low-cost configuration of the device, the pumps are arranged in the direct vicinity of the tanks or the pump circulation tanks.

A method according to the invention for modifying the treatment device to effect cleaning of a-metal strip by means of a treatment liquid, particularly a pickling liquid, the metal strip preferably being guided horizontally through at least one tank, in particular a deep tank, for accommodating the treatment liquid, is made up of the following features:

The existing tanks, in particular deep tanks of a deep-tank strip cleaning installation, are removed. A shallow tank and one or more pump circulation tanks are installed in place of each of the tanks removed.

On the basis of these measures, the deep tanks are replaced by the advantageous shallow tanks and the treatment result is improved. The combined arrangement, with the pump circulation tank or tanks arranged directly under the shallow tank, also offers advantages for the modifying process in addition to the operational advantages.

The modifying method described is distinguished by a low space requirement and minor necessary structural changes or additions, since no additional space requirement is caused by the modification. On account of the more minor structural measures, shorter and less costly modification phases can be realized. The combination of components also allows a shorter assembly phase to be achieved.

The invention is represented in various special embodiments in the schematic drawings listed below:

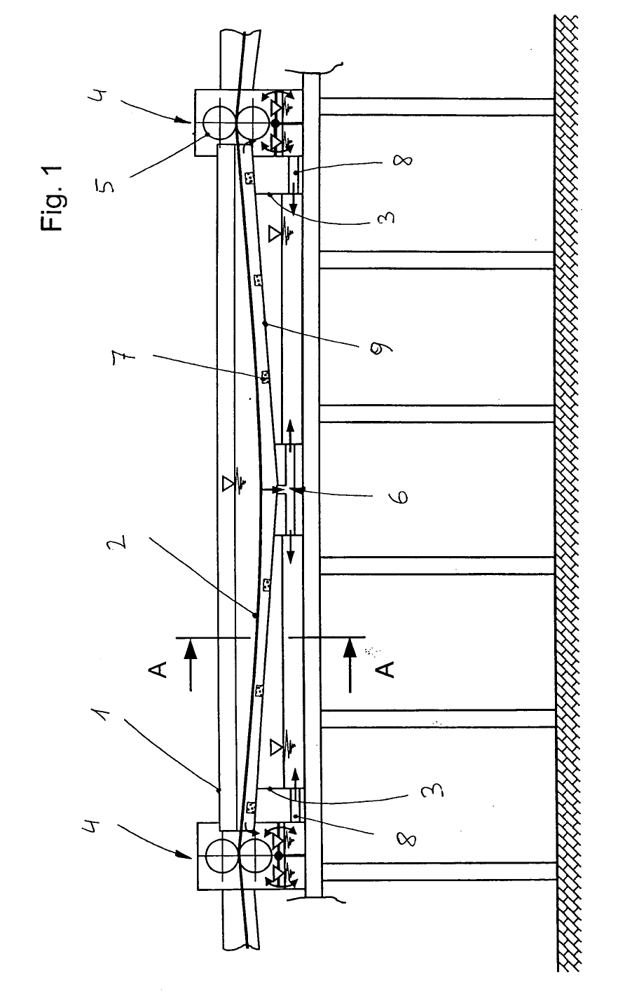

FIG. 1 shows an arrangement of the devices of the treatment installation,

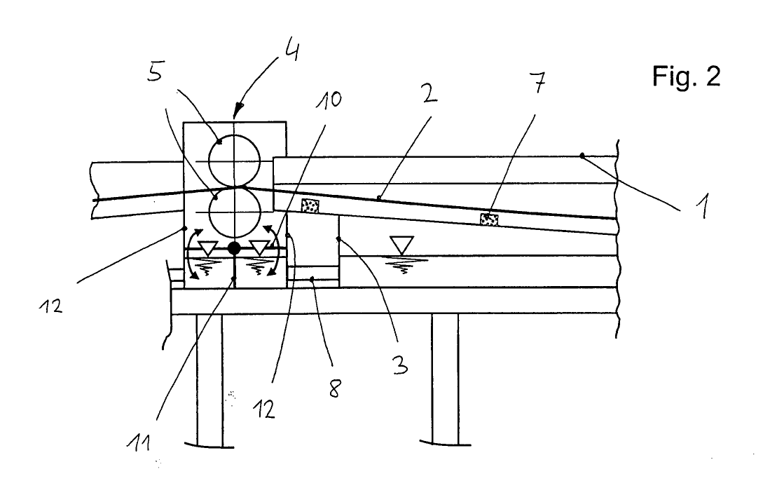

FIG. 2 shows a detail from FIG. 1 of the devices of the treatment installation,

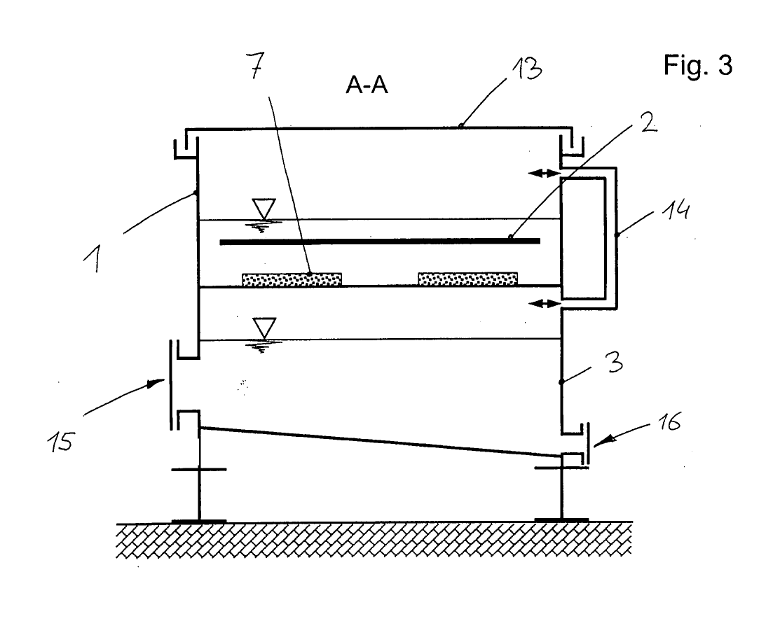

FIG. 3 shows a sectional representation of the treatment installation in a preferred embodiment and

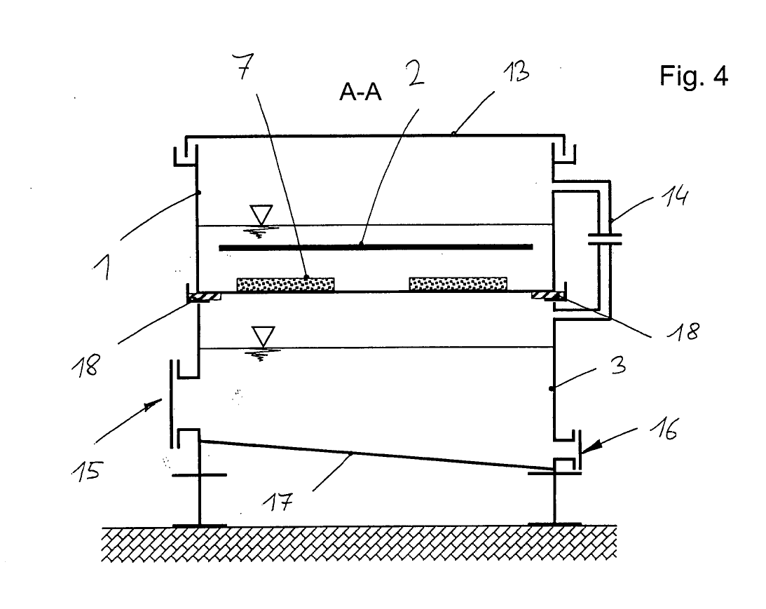

FIG. 4 shows a sectional representation of the treatment installation in a further preferred embodiment.

According to FIG. 1, the treatment device is schematically represented in elevation and in the form of a detail. In the embodiment represented, two pump circulation tanks 3 are arranged on a supporting structure, which is only indicated here. These pump circulation tanks 3 are positioned directly under the tank 1. The tank 1 serves for accommodating the treatment liquid, preferably a pickling liquid. A metal strip 2 to be treated is guided through the tank 1, substantially horizontally, the metal strip 2 being cleaned by the interaction with the treatment liquid. Protective devices 7 to protect the tank 1 from being damaged by the metal strip 2 are arranged in the tank 1.

Arranged at the inlet and outlet of the tank 1 are run-off chambers 4, which also accommodate the squeeze rolls 5.

The pump circulation tanks 3, arranged directly under the tank 1, are connected to the tank 1 via the run-off chambers 4 and a centrally arranged run-off 6. The run-off chambers 4 are respectively connected to a pump circulation tank via lines 8.

The run-off 6 and the lines 8 are designed in such a way that thermally induced changes in length in the parts of the device can be accommodated. In the tank 1, in the pump circulation tanks 3 and in the run-off chambers 4, the amounts of liquid are indicated by means of the liquid levels. The tank 1 has a bottom 9 sloping down toward the run-off 6, which ensures that no residues of the treatment liquid remain in the tank 1 during emptying of the tank 1.

FIG. 2 shows an enlarged detail from FIG. 1. In the run-off chambers 4 there are flaps 10, which are arranged between a separating wall 11 and the outside wall 12 of a run-off chamber 4, can be actuated from the outside and close in a gastight manner.

In FIG. 3, a preferred embodiment of the device according to the invention is represented in a sectional representation, corresponding to the sectional line A-A indicated in FIG. 1.

The tank 1 and the preferably two pump circulation chambers 3 are configured as a unit. For gastight closure, the tank 1 has a cover 13. The tank 1 and the pump circulation tanks 3 are connected via a connecting line 14. The pump circulation tanks have in each case at least one manhole or cleaning opening 15 and at least one emptying stub 16. The bottom 17 has a slope leading down to the emptying stub, this slope being aligned transversely in relation to the running direction of the metal strip 2 and extending over the entire length of the pump circulation tank.

FIG. 4 shows a further preferred embodiment of the device according to the invention. The tank 1 is mounted on the preferably two pump circulation tanks 3. The contact surface between the tank 1 and the pump circulation tanks 3 is closed in a gastight manner by means of seals 18. The tank 1 and the pump circulation tanks 3 are connected via a couplable line 14, whereby a gas exchange is made possible.

1. A device for effecting continuous treatment of a metal strip by means of a treatment liquid, comprising:
at least one tank treatment for accommodating a treatment liquid:
a guide for guiding the metal strip through the at least one treatment tank for accommodating a treatment liquid;
at least one pump circulation tank for at least one of preparing, storing and holding the treatment liquid, the pump circulation tank being arranged directly under the treatment tank, the at least one pump circulation tank having a bottom with a slope over its entire length, wherein the slope is aligned in at least one of in the strip running direction and transversely in relation to the strip running direction.

2. The device as claimed in claim 1, wherein the treatment tank is configured as a shallow tank.

3. The device as claimed in claim 2, further comprising at least one cover on the treatment tank.

4. The device as claimed in claim 1, wherein the pump circulation tank and the treatment tank form a unit.

5. The device as claimed claim 1, wherein the treatment tank * is structurally mounted on the at least one pump circulation tank.

6. The device as claimed in claim 1, further comprising a contact surface between the treatment tank and the at least one pump circulation tank and a seal in the contact surface.

7. The device as claimed in claim 1, wherein the treatment tank has a bottom that forms a cover for the at least one pump circulation tank.

8. The device as claimed in claim 1, wherein the treatment tank and the pump circulation tank comprised of a plastic, polypropylene.

9. The device as claimed in claim 1, wherein the treatment tank and the at least one pump circulation tank are comprised of rubberized steel.

10. The device as claimed in claim 1, further comprising run-off chambers or at least one run-off accommodating a change in length connecting the treatment tank to the at least one pump circulation tank.

11. The device as claimed in claim 10, wherein the run-off ( is arranged centrally in the tank in the strip running direction.

12. The device as claimed in claim 10, wherein the treatment tank has a bottom sloping down toward the run-off.

13. The device as claimed in claim 1, further comprising a space in the run-off chamber between a separating wall in the run-off chamber and an outside wall of the run-off chamber, a flap closing the space in a gastight manner and the flap can be actuated from outside the tanks and the chamber.

14. The device as claimed in claim 1, further comprising at least one connecting line is arranged between the pump circulation tank and the treatment tank for at least one of ventilating and venting the pump circulation tank.

15. The device as claimed in claim 1, further comprising pumps for pumping treatment liquid is from the at least one pump circulation tank ( into the treatment tank.

16. A method for modifying a treatment device, for a metal strip by of a treatment liquid, wherein the metal strip is guided, through at least one treatment tank, for accommodating the treatment liquid, the method comprising:
removing the treatment tank,
installing a shallow treatment tank and a pump circulation tank in place of the removed treatment tank wherein,
the pump circulation tank, has a bottom with a slope over the entire length of the bottom, wherein the slope is aligned in at least one of the strip running direction and transversely in relation to the strip running direction, for causing largely complete emptying of the pump circulation tank or the shallow treatment tank.

17. The method as claimed in claim 16, wherein the shallow treatment tank has a bottom with a slope over the entire length, the slope being aligned in the strip running direction.

18. The method as claimed in claim 15, further comprising arranging the at least one pump circulation tank directly under the shallow tank.

19. The method as claimed in claim 16, wherein the metal strip is guided horizontally and the treatment liquid is a pickling liquid.

20. The device as claimed in claim 1, wherein the guide is operable to guide the strip horizontally through the treatment tank.
